(19) United States
(12) Patent Application Publication
(10) Pub. No.: US 2018/0190294 A1
(43) Pub. Date: Jul. 5, 2018

(54) INPUT METHOD AND APPARATUS

(71) Applicant: BEIJING BAIDU NETCOM SCIENCE AND TECHNOLOGY CO., LTD., Beijing (CN)

(72) Inventors: Xiaojun YUAN, Beijing (CN); Han Xia, Beijing (CN)

(73) Assignee: BEIJING BAIDU NETCOM SCIENCE AND TECHNOLOGY CO., LTD., Beijing (CN)

(21) Appl. No.: 15/859,206

(22) Filed: Dec. 29, 2017

(30) Foreign Application Priority Data
Jan. 3, 2017 (CN) 2017100004877

(51) Int. Cl. G10L 15/26; G10L 15/08; G06F 3/16; G10L 15/22

(52) U.S. Cl. CPC G10L 15/265; G10L 15/22; G06F 3/167; G10L 15/08

(57) ABSTRACT

The present disclosure provides an input method and apparatus, wherein the method comprises: displaying a speech collecting control on a current interface after a word input function is triggered; collecting speech data after the speech collecting control is triggered; upon completion of the speech data collection, converting the collected speech data into words, and displaying the words obtained from the conversion on the screen. In the present disclosure, it is only necessary to display the speech collecting control on the current interface during the whole word input procedure, without popping up the word input method panel that occupies a lot of screen space. The user may input speech after triggering the speech collecting control, thereby achieving automatic conversion and input of words without requiring the user to put in a lot of energy to manually input words. The present disclosure is particularly adapted for application scenarios such as gaming type applications, video type applications and navigation type applications, improves the user's input efficiency and also reduces the input method's impact on the experience of using the original interface.

The present application claims the priority of Chinese Patent Application No. 201710000487.7, filed on Jan. 3, 2017, with the title of “Input method and apparatus”.

### FIELD OF THE DISCLOSURE

The present disclosure relates to the technical field of computer application, and particularly to an input method and apparatus.

BACKGROUND OF THE DISCLOSURE

If a user wants to input words, a commonly-selected input manner is inputting by pressing keys according to pinyin or strokes. This manner makes a popup input method panel occupy about ⅓-½ of a screen space. The screen space of a mobile terminal is very limited. A too small input method panel affects the user's input experience. However, if the input method panel is too large, a scenario such as game or video affects the user's experience in using the original interface. For example, if a user who is playing a game wants to communicate with his team members, the input method panel needs to pop up. The input method panel blocks a large portion of the playing picture on the one hand, and on the other hand, the user needs to take time to input words, which certainly affects the experience of the game which is played.

### SUMMARY OF THE DISCLOSURE

In view of the above, the present disclosure provides an input method and apparatus to reduce the input method's impact on the experience of using the original interface.

Specific technical solutions are as follows:

The present disclosure provides an input method, the method comprising:

displaying a speech collecting control on a current interface after a word input function is triggered;

collecting speech data after the speech collecting control is triggered;

upon completion of the speech data collection, converting the collected speech data into words, and displaying the words obtained from the conversion on the screen.

According to a preferred embodiment of the present disclosure, the word input function being triggered comprises:

an input box on the interface is clicked.

According to a preferred embodiment of the present disclosure, after trigging the word input function is executed under a preset application scenario, the speech collecting control is displayed on the current interface; otherwise, after the word input function is triggered, a word input method panel is displayed on the current interface.

According to a preferred embodiment of the present disclosure, the preset application scenario include: gaming type applications, video type applications, navigation type applications or applications pre-designated by the user.

According to a preferred embodiment of the present disclosure, displaying the speech collecting control on the current interface comprises:

displaying a floating layer including the speech collecting control on the current interface, the floating layer being transparent or having a size smaller than the word input method panel; or

displaying a strip-shaped panel including the speech collecting control at an edge of the current interface, the strip-shaped panel being transparent or having a size smaller than the word input method panel.

According to a preferred embodiment of the present disclosure, the floating layer or the strip-shaped panel further comprises:

a control for shifting the word input method panel.

According to a preferred embodiment of the present disclosure, after the control for shifting the word input method panel is triggered, the word input method panel is displayed and the display of the floating layer or strip-shaped panel is cancelled.

According to a preferred embodiment of the present disclosure, when the speech collecting control is pressed, speech data is collected;

when the speech collecting control is released, speech data collection is finished.

According to a preferred embodiment of the present disclosure, the method further comprises:

sending and cleaning up words displayed on the screen, after a word sending function is triggered.

According to a preferred embodiment of the present disclosure, the method further comprises:

cancelling the display of the speech collecting control after the word sending function is triggered.

The present disclosure further provides an input apparatus, comprising:

a control display unit configured to display a speech collecting control on a current interface after a word input function is triggered;

a speech collecting unit configured to collect speech data after the speech collecting control is triggered;

a word converting unit configured to, upon completion of the speech data collection, convert the collected speech data into words;

a word displaying unit configured to display the words obtained from the conversion of the word converting unit on the screen.

According to a preferred embodiment of the present disclosure, the apparatus further comprises:

a detecting unit configured to trigger the word input function upon detecting that an input box on the interface is clicked.

According to a preferred embodiment of the present disclosure, the control displaying unit is further configured to, after the word input function is triggered, judge whether an application scenario of the current interface belongs to preset application scenarios; if yes, execute the display of the speech collecting control on the current interface; if no, display the word input method panel on the current interface.

According to a preferred embodiment of the present disclosure, the preset application scenarios include: gaming type applications, video type applications, navigation type applications or applications pre-designated by the user.

According to a preferred embodiment of the present disclosure, the control displaying unit specifically executes the following upon displaying the speech collecting control on the current interface:

displaying a floating layer including the speech collecting control on the current interface, the floating layer being transparent or having a size smaller than the word input method panel; or

displaying a strip-shaped panel including the speech collecting control at an edge of the current interface, the strip-shaped panel being transparent or having a size smaller than the word input method panel.

According to a preferred embodiment of the present disclosure, the floating layer or the strip-shaped panel further comprises:

a control for shifting the word input method panel.

According to a preferred embodiment of the present disclosure, the control displaying unit is further configured to, after the control for shifting the word input method panel is triggered, display the word input method panel and cancel the display of the floating layer or strip-shaped panel.

According to a preferred embodiment of the present disclosure, the speech collecting unit is specifically configured to, when the speech collecting control is pressed, collect speech data; and finish speech data collection when the speech collecting control is released.

According to a preferred embodiment of the present disclosure, the apparatus further comprises:

a word sending unit configured to send words displayed on the screen, after a word sending function is triggered, and trigger the word displaying unit to clean up words displayed on the screen.

According to a preferred embodiment of the present disclosure, the control displaying unit is further configured to cancel the display of the speech collecting control after the word sending function is triggered.

As can be seen from the above technical solutions, in the present disclosure, it is only necessary to display the speech collecting control on the current interface during the whole word input procedure, without popping up the word input method panel that occupies a lot of screen space. The user may input speech after triggering the speech collecting control, thereby achieving automatic conversion and input of words without requiring the user to put in a lot of energy to manually input words. The present disclosure is particularly adapted for application scenarios such as gaming type applications, video type applications and navigation type applications, improves the user's input efficiency and also reduces the input method's impact on the experience of using the original interface.

### BRIEF DESCRIPTION OF DRAWINGS

FIG. 1 is a flow chart of a method according to an embodiment of the present disclosure;

FIG. 2 is a schematic diagram of an input method setting interface according to an embodiment of the present disclosure;

FIG. 3a and FIG. 3b are schematic diagrams demonstrating a speech collecting control according to an embodiment of the present disclosure;

FIG. 4a and FIG. 4b are schematic diagrams showing display of words on a screen;

FIG. 5 is a structural diagram of an apparatus according to an embodiment of the present disclosure;

FIG. 6 is a structural diagram of a device according to an embodiment of the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

Terms used in embodiments of the present disclosure are only intended to describe specific embodiments, not to limit the present disclosure. Singular forms “a”, “said” and “the” used in embodiments and claims of the present disclosure are also intended to include plural forms, unless other senses are clearly defined in the context.

It should be appreciated that the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

Depending on the context, the word “if” as used herein may be construed as “at the time when . . . ” or “when . . . ” or “responsive to determining” or “responsive to detecting”. Similarly, depending on the context, phrases “if . . . is determined” or “if . . . (stated condition or event) is detected” may be construed as “when . . . is determined” or “responsive to determining” or “when . . . (stated condition or event) is detected” or “responsive to detecting (stated condition or event)”.

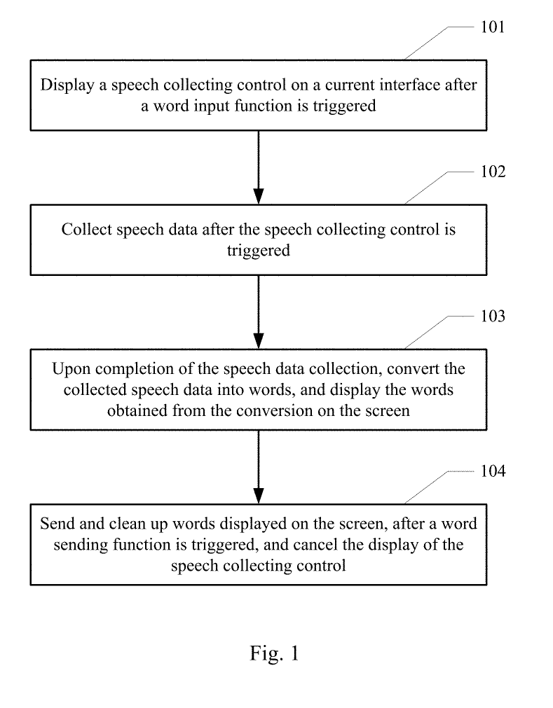

FIG. 1 is a flow chart of a method according to an embodiment of the present disclosure. As shown in FIG. 1, the method may comprise the following steps:

In 101, after a word input function is triggered, a speech collecting control is displayed on a current interface.

The method provided by the embodiment of the present disclosure can be applied to any application such as shopping type application, payment type application, news type application and social type application. Even though the word input method panel temporarily blocks the interface, the blocking does not exert too much impact on use experience of these applications. However, the blocking of the interface by the word input method panel exerts a very large impact on experience of using applications such as gaming type application, video type application and navigation type application. Therefore, in the embodiment of the present disclosure, some application scenarios may be preset. Under these application scenarios, if the word input function is triggered, the speech collecting control is displayed. As for other application scenarios, the word input method panel is displayed in a manner in the prior art.

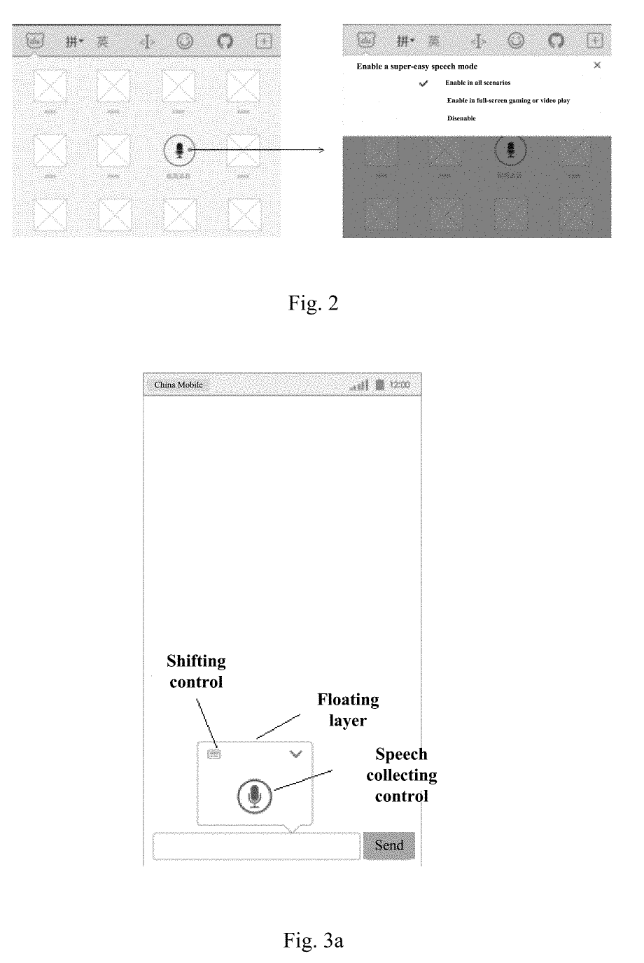

The above preset application scenarios may employ a default setting, for example, it is set by default that gaming type application, video type application and navigation type application employ the input method of the present disclosure; other types of applications employ the input methods in the prior art. Alternatively, the above application scenarios may be set by the user in an input method setting interface. As shown in FIG. 2, the user enters the input method setting interface shown in the left diagram of FIG. 2, clicks a microphone icon therein and enters a sub-interface shown in the right diagram of FIG. 2, selects an application type to enable a super-easy voice input function (namely, the input method provided by the embodiments of the present disclosure). For example, the user may choose to enable the function in all scenarios or choose to enable the function during full-screen gaming or video playing, or choose not to enable the function. It needs to be appreciated that FIG. 2 only shows an instance of a kind of setting interface. It is further possible to provide, in the interface, an application listing that may enable the super-easy voice input function. The user may select some application scenarios from the application listing to enable the super-easy voice input function.

While the user uses the application, if the word input function is triggered, for example, the input box on the interface is clicked, a speech collecting control is displayed on the current interface, wherein the form of displaying the speech collecting control may employ but is not limited to the following two kinds:

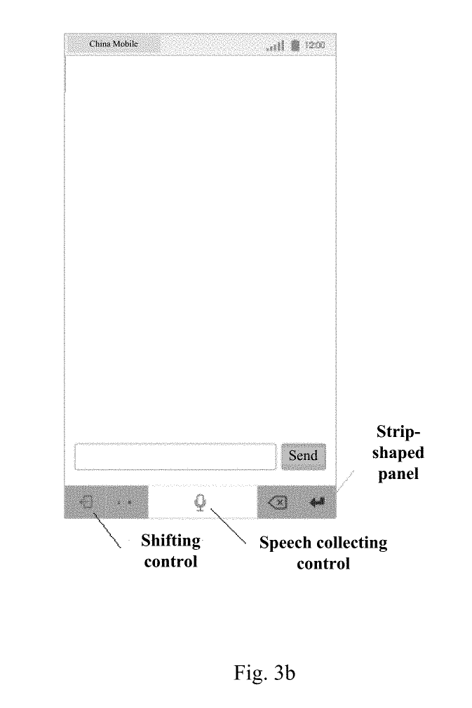

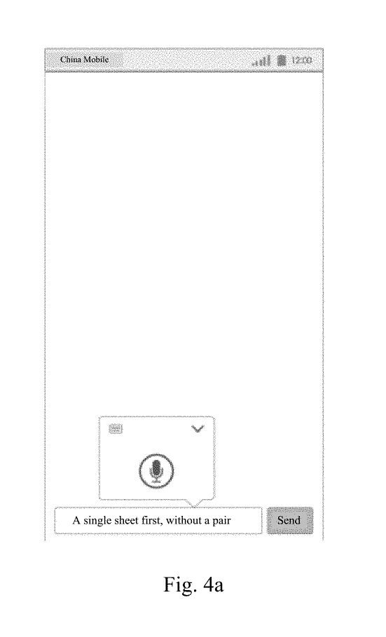

The first form: on the current interface is displayed a floating layer including the speech collecting control, and the floating layer is transparent or has a size smaller than the word input method panel. As shown in FIG. 3a, if the input box on the current interface is clicked, a small floating layer is displayed, the floating layer may be transparent or have a very small size so long as it can accommodate the speech collecting control and facilitate the user's click. The floating layer does not exert an impact on display of the original content on the interface. For example, a game, video, navigation path or the like is going on the original interface.

The floating layer may further comprise a control for shifting the word input method panel, briefly called “a shifting control”. If the user triggers the shifting v control, the word input method panel is displayed and the display of the floating layer including the speech collecting control is cancelled. That is to say, the user may further select an ordinary word input method to input words.

The second form: a strip-shaped panel including the speech collecting control is displayed at an edge of the current interface, and the strip-shaped panel is transparent or has a size smaller than the word input method panel. As shown in FIG. 3B, if the input block on the current interface is clicked, a strip-shaped panel may be displayed at a lower edge of the interface and includes the speech collecting control. The size of the strip-shaped panel is very small and it is feasible so long as it can accommodate the speech collecting control and facilitate the user's click. In addition to a small size, the strip-shaped panel is located at the edge of the interface, for example a lower edge, an upper edge, a left edge or a right edge, and is not intended to exert a too large impact on the content on the original interface.

Additionally, the strip-shaped panel may further comprise edit type controls such as deletion and symbols so that the user may simply edit the words input in a speech mode.

The strip-shaped panel may also include a control for shifting the word input method panel, briefly called “a shifting control”. If the user triggers the shifting control, the word input method panel is displayed and the display of the strip-shaped panel including the speech collecting control is cancelled. That is to say, the user may further select an ordinary word input method to input words.

In 102, speech data is collected after the speech collecting control is triggered.

After the user presses the speech collecting control shown in FIG. 3a or FIG. 3b, the speech data begins to be collected, and the user may input content in a speech manner. When the user finishes the speech input, he releases the speech collecting control and the speech data collection is finished. Certainly, there further may be other manners of triggering the speech collecting control, in addition to pressing and releasing, for example, clicking the speech collecting control to start collecting the speech data, and then clicking the speech collecting control again to finish the speech data collection; again for example, clicking the speech collecting control to start collecting the speech data, and automatically finishing the speech data collection when it is recognized that speech is not input in a certain period of time.

In 103, upon completion of the speech data collection, the collected speech data are converted into words, and the words obtained from the conversion are displayed on the screen.

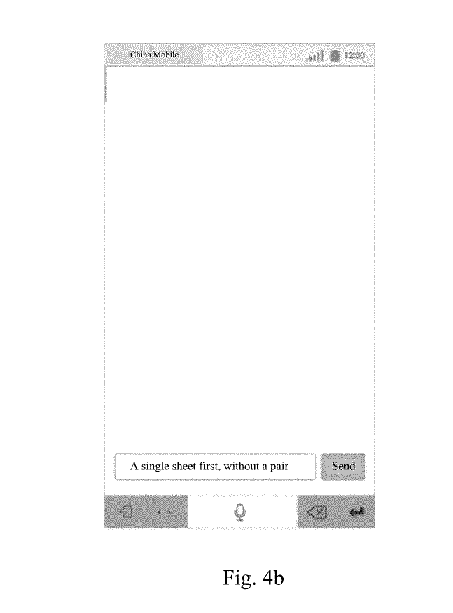

In this step, the collected speech data are recognized in a speech recognition manner, and recognized into words, then the words are displayed on the screen, namely, displayed in the input box. For example, if the user, during gaming, presses the speech collecting control in FIG. 3a to collect the speech and inputs the speech “a single sheet first, without a pair”, the speech undergoes speech recognition and then is converted into corresponding words which are then displayed in the input box, as shown in FIG. 4a.

For another example, if the user presses the speech collecting control in FIG. 3b to collect the speech and inputs the speech “a single sheet first, without a pair”, the speech undergoes speech recognition and then is converted into corresponding words which are then displayed in the input box, as shown in FIG. 4b. The user may further perform simple editing through the editing control on the strip-shaped panel, for example, deletion, insertion of characters or the like.

In 104, after the word sending function is triggered, words displayed on the screen are sent and cleaned up, and the display of the speech collecting control is cancelled.

After a word sending function is triggered, the words in the input box are sent. The words may be sent to a designated contact, for example, to a team member in a gaming application. The words may also be sent to a server, for example, in a navigation type application, after the user inputs through speech, the speech is converted into a word instruction which is sent to the server. It is also possible that after the words are sent to the server, the server displays them on the interface. For example, in a video type application, the user may inputs commentary information in a speech input manner, then the speech is converted into words which are then sent to the server, and the server displays the user's comments on the video interface in a barrage manner. Other forms may also possible and will not be exhausted one by one here.

After word transmission is finished, the words displayed in the input box are removed, display of the floating layer or strip-shaped panel including the speech collecting control is cancelled, and so far, one-time word input is finished.

A subject for implementing the above method embodiment may be an input device, the input device may be located in an application of a mobile terminal, or may further be a function unit such as a plug-in or Software Development Kit (SDK) located in the input method application of the mobile terminal, or may be located on a server side. This is not particularly limited in the present embodiment.

The above describes the method according to the present disclosure. An apparatus according to the present disclosure will be described in detail below in conjunction with embodiments.

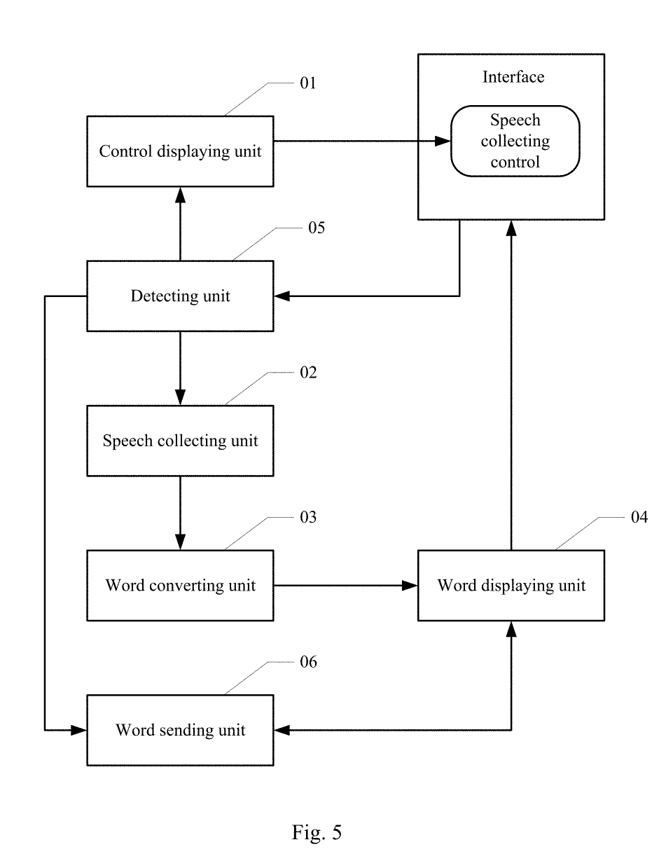

FIG. 5 is a structural diagram of an apparatus according to an embodiment of the present disclosure. As shown in FIG. 5, the apparatus may comprises a control displaying unit 01, a speech collecting unit 02, a word converting unit 03 and a word displaying unit 04, and may further comprise a detecting unit 05 and a word sending unit 06. Main functions of the units are as follows:

The control displaying unit 01 is configured to display a speech collecting control on a current interface after a word input function is triggered.

The method provided by the embodiment of the present disclosure can be applied to any application such as a shopping type application, payment type application, news type application and social type application. Even though the word input method panel temporarily blocks the interface, the blocking does not exert too much impact on use experience of these applications. However, the blocking of the interface by the word input method panel exerts a very large impact on experience of using applications such as gaming type application, video type application and navigation type application. Therefore, in the embodiment of the present disclosure, some application scenarios may be preset. Under these application scenarios, if the word input function is triggered, the speech collecting control is displayed. As for other application scenarios, the word input method panel is displayed in a manner in the prior art. That is to say, the control displaying unit 01 judges whether the application scenario of the current interface belongs to a preset application scenario after the word input function is triggered; if yes, displays the speech collecting control on the current interface; if no, displays the word input method panel on the current interface.

The above preset application scenarios may include but not included to: gaming type applications, video type applications, navigation type applications or applications pre-designated by the user.

In the embodiment of the present disclosure, the triggering of the functions on the interface may be executed by the detecting unit 05. After capturing a user's gesture, an operating system sends corresponding events to the detecting unit 05, and the detecting unit 05 judges whether a function is triggered and what function is triggered, based on these events. For example, the detecting unit 05 triggers the word input function upon detecting an event that the input box on the interface is clicked. The form of displaying the speech collecting control may employ but is not limited to the following two kinds:

The first form: on the current interface is displayed a floating layer including the speech collecting control, and the floating layer is transparent or has a size smaller than the word input method panel. As shown in FIG. 3a, if the input box on the current interface is clicked, a small floating layer is displayed, the floating layer may be transparent or have a very small size so long as it can accommodate the speech collecting control and facilitate the user's click. The floating layer does not exert an impact on display of the original content on the interface. For example, a game, video, navigation path or the like is going on the original interface.

The floating layer may further comprise a control for shifting the word input method panel, briefly called “a shifting control”. If the user triggers the shifting control, the control displaying unit 01 displays the word input method panel and cancels the display of the floating layer including the speech collecting control. That is to say, the user may further select an ordinary word input method to input words.

The second form: a strip-shaped panel including the speech collecting control is displayed at an edge of the current interface, and the strip-shaped panel is transparent or has a size smaller than the word input method panel. As shown in FIG. 3b, if the input block on the current interface is clicked, a strip-shaped panel may be displayed at a lower edge of the interface and includes the speech collecting control. The size of the strip-shaped panel is very small and it is feasible so long as it can accommodate the speech collecting control and facilitate the user's click. In addition to a small size, the strip-shaped panel is located at the edge of the interface, for example a lower edge, an upper edge, a left edge or a right edge, and is not intended to exert a too large impact on the content on the original interface.

Additionally, the strip-shaped panel may further comprise edit type controls such as deletion and symbols so that the user may simply edit the words input in a speech mode.

The strip-shaped panel may also include a control for shifting the word input method panel, briefly called “a shifting control”. If the user triggers the shifting control, the control displaying unit 01 displays the word input method panel and cancels the display of the strip-shaped panel including the speech collecting control. That is to say, the user may further select an ordinary word input method to input words.

The speech collecting unit 02 is configured to collect speech data after the speech collecting control is triggered.

When the speech collecting control is pressed, the speech collecting unit 02 collects the speech data; when the speech collecting control is released, the speech collecting unit 02 finishes speech data collection. Certainly, there further may be other manners of triggering the speech collecting control, in addition to pressing and releasing, for example, clicking the speech collecting control to start collecting the speech data, and then clicking the speech collecting control again to finish the speech data collection; again for example, clicking the speech collecting control to start collecting the speech data, and automatically finishing the speech data collection when it is recognized that speech is not input in a certain period of time.

The word converting unit 03 is configured to, upon completion of the speech data collection, convert the collected speech data into words.

The word displaying unit 04 is configured to display the words obtained from the conversion of the word converting unit 03 on the screen, namely, display the words in the input box on the interface.

The word sending unit 06 is configured to, after a word sending function is triggered, send the words displayed on the screen and trigger the word displaying unit 04 to clean up the words displayed on the screen. Meanwhile, the control displaying unit 01 cancels the display of the speech collecting control after the word sending function is triggered. So far, one-time word input is finished.

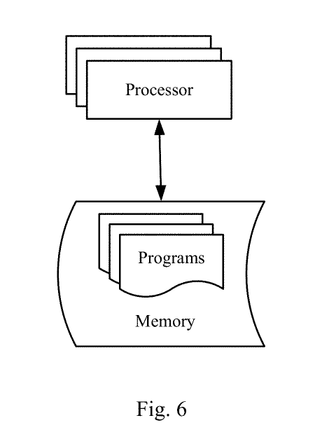

The method and apparatus according to embodiments of the present disclosure may be reflected with a computer program which is set in and runs in a device. The device may comprise one or more processors, and may further comprise a memory and one or more programs, as shown in FIG. 6. The one or more programs are stored in a memory and executed by said one or more processors to implement the steps of the method and/or operations of the apparatus shown in the above embodiments of the present disclosure. For example, the steps of the method executed by said one or more processors may comprise:

displaying a speech collecting control on a current interface after a word input function is triggered;

collecting speech data after the speech collecting control is triggered;

upon completion of the speech data collection, converting the collected speech data into words, and displaying the words obtained from the conversion on the screen.

Several application scenarios are listed below:

### Application Scenario 1

If a user wants to input words to communicate with team members while playing a game on a mobile device, he may employ the input manner stated in the embodiments of the present disclosure. Since only a floating layer including the speech collecting control or a strip-shaped panel at the edge of the interface is generated on the screen, and the floating layer or strip-shaped panel is transparent or has a very small size, it does not hinder the display of content of the game that is going on; on the other hand, since the user inputs through speech and the speech is converted into words, this does not occupy excessive energy of the user so that the user can obtain better experience while playing the game.

### Application Scenario 2

If the user wants to input commentary information while viewing a video on a mobile device, he may employ the input method as stated in embodiments of the present disclosure and display the input words on the screen in a manner such as barrage. Since only a floating layer including the speech collecting control or a strip-shaped panel at the edge of the interface is generated on the screen, and the floating layer or strip-shaped panel is transparent or has a very small size, it does not hinder the display of content of the game that is going on; on the other hand, since the user inputs through speech and the speech is converted into words, this does not occupy excessive energy of the user so that the user does not miss viewing the view and obtains better experience.

### Application Scenario 3

If the user wants to input a new query item while using navigation service on the mobile device, he may employ the input manner stated in embodiments of the present disclosure. Since only a floating layer including the speech collecting control or a strip-shaped panel at the edge of the interface is generated on the screen, and the floating layer or strip-shaped panel is transparent or has a very small size, it does not hinder the display of the original navigation on the interface; on the other hand, since the user inputs through speech and the speech is converted into words, this does not occupy excessive energy of the user so that the user can drive the car attentively and thereby obtain better use experience.

In the embodiments provided by the present disclosure, it should be understood that the revealed apparatus and method can be implemented through other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

What are stated above are only preferred embodiments of the present disclosure, not intended to limit the disclosure. Any modifications, equivalent replacements, improvements and the like made within the spirit and principles of the present disclosure, should all be included in the scope of protection of the present disclosure.

What is claimed is:

1. An input method, wherein the method comprises:
displaying a speech collecting control on a current interface after a word input function is triggered;
collecting speech data after the speech collecting control is triggered;
upon completion of the speech data collection, converting the collected speech data into words, and displaying the words obtained from the conversion on the screen.

2. The method according to claim 1, wherein the word input function being triggered comprises:
an input box on the interface is clicked.

3. The method according to claim 1, wherein displaying a speech collecting control on a current interface after a word input function is triggered is executed under a preset application scenario; otherwise, after the word input function is triggered, a word input method panel is displayed on the current interface, wherein the preset application scenario comprises: gaming type applications, video type applications, navigation type applications or applications pre-designated by the user.

4. (canceled)

5. The method according to claim 1, wherein displaying the speech collecting control on the current interface comprises:
displaying a floating layer comprising the speech collecting control on the current interface, the floating layer being transparent or having a size smaller than the word input method panel; or
displaying a strip-shaped panel comprising the speech collecting control at an edge of the current interface, the strip-shaped panel being transparent or having a size smaller than the word input method panel.

6. The method according to claim 5, wherein the floating layer or the strip-shaped panel further comprises:
a control for shifting the word input method panel, wherein after the control for shifting the word input method panel is triggered, the word input method panel is displayed and the display of the floating layer or strip-shaped panel is cancelled.

7. (canceled)

8. The method according to claim 1, wherein when the speech collecting control is pressed, speech data is collected;
when the speech collecting control is released, speech data collection is finished.

9. The method according to claim 1, wherein the method further comprises:
after a word sending function is triggered, sending and cleaning up words displayed on the screen, and/or, cancelling the display of the speech collecting control.

10-20. (canceled)

21. A device, wherein the device comprises:
one or more processors;
a memory;
one or more programs stored in the memory and configured to execute the following operation when executed by the one or more processors:
displaying a speech collecting control on a current interface after a word input function is triggered;
collecting speech data after the speech collecting control is triggered;
upon completion of the speech data collection, converting the collected speech data into words, and displaying the words obtained from the conversion on the screen.

22. The device according to claim 8, wherein the word input function being triggered comprises:
an input box on the interface is clicked.

23. The device according to claim 8, wherein displaying a speech collecting control on a current interface after a word input function is triggered is executed under a preset application scenario; otherwise, after the word input function is triggered, a word input method panel is displayed on the current interface;
wherein the preset application scenario comprises: gaming type applications, video type applications, navigation type applications or applications pre-designated by the user.

24. The device according to claim 8, wherein displaying the speech collecting control on the current interface comprises:
displaying a floating layer comprising the speech collecting control on the current interface, the floating layer being transparent or having a size smaller than the word input method panel; or
displaying a strip-shaped panel comprising the speech collecting control at an edge of the current interface, the strip-shaped panel being transparent or having a size smaller than the word input method panel.

25. The device according to claim 11, wherein the floating layer or the strip-shaped panel further comprises a control for shifting the word input method panel;
wherein after the control for shifting the word input method panel is triggered, the word input method panel is displayed and the display of the floating layer or strip-shaped panel is cancelled.

26. The device according to claim 8, wherein when the speech collecting control is pressed, speech data is collected;
when the speech collecting control is released, speech data collection is finished.

27. The device according to claim 8, wherein the operation further comprises:
after a word sending function is triggered, sending and cleaning up words displayed on the screen, and/or, cancelling the display of the speech collecting control.

28. A non-volatile computer storage medium in which one or more programs are stored, an apparatus being enabled to execute the following operation when said one or more programs are executed by the apparatus:
displaying a speech collecting control on a current interface after a word input function is triggered;
collecting speech data after the speech collecting control is triggered;
upon completion of the speech data collection, converting the collected speech data into words, and displaying the words obtained from the conversion on the screen.

29. The non-volatile computer storage medium according to claim 15, wherein the word input function being triggered comprises:
an input box on the interface is clicked.

30. The non-volatile computer storage medium according to claim 15, wherein displaying a speech collecting control on a current interface after a word input function is triggered is executed under a preset application scenario; otherwise, after the word input function is triggered, a word input method panel is displayed on the current interface;
wherein the preset application scenario comprises: gaming type applications, video type applications, navigation type applications or applications pre-designated by the user.

31. The non-volatile computer storage medium according to claim 15, wherein displaying the speech collecting control on the current interface comprises:
displaying a floating layer comprising the speech collecting control on the current interface, the floating layer being transparent or having a size smaller than the word input method panel; or
displaying a strip-shaped panel comprising the speech collecting control at an edge of the current interface, the strip-shaped panel being transparent or having a size smaller than the word input method panel.

32. The non-volatile computer storage medium according to claim 18, wherein the floating layer or the strip-shaped panel further comprises a control for shifting the word input method panel;
wherein after the control for shifting the word input method panel is triggered, the word input method panel is displayed and the display of the floating layer or strip-shaped panel is cancelled.

33. The non-volatile computer storage medium according to claim 15, wherein when the speech collecting control is pressed, speech data is collected;
when the speech collecting control is released, speech data collection is finished.

34. The non-volatile computer storage medium according to claim 15, wherein the operation further comprises:
after a word sending function is triggered, sending and cleaning up words displayed on the screen, and/or, cancelling the display of the speech collecting control.
